(19) United States
(12) Patent Application Publication
(10) Pub. No.: US 2012/0049515 A1
(43) Pub. Date: Mar. 1, 2012

(54) Boltless Pipe Joint Assembly

(76) Inventor: Sam Hietpas, Little Chute, WI (US)

(21) Appl. No.: 13/217,017

(22) Filed: Aug. 24, 2011

Related U.S. Application Data
(60) Provisional application No. 61/376,520, filed on Aug. 24, 2010.

(51) Int. Cl. F16L 19/025; F16L 19/075

(52) U.S. Cl. 285/349; 285/363; 285/364

(57) ABSTRACT

A boltless mechanical pipe joint uses an singly cast segment of joint pipe, bell housing with internal gasket recess and flange to secure pipe segments, including water main segments. The bell housing is elongated to accommodate the internal gasket recess, prefabricated and precisely placed gasket and flange. The flange receives a plurality of restraint components which secure the boltless pipe joint to a second pipe segment. The elongated bell housing also provides additional support.

### CROSS-REFERENCE TO RELATED APPLICATION

This application claims priority to U.S. Provisional Application No. 61/376,520 filed Aug. 24, 2010.

### FIELD OF INVENTION

The present invention relates to the field of water main pipe joints, and more specifically to a pipe joint component adapted to be configured for attachment to a water main by above-ground.

### BRIEF DESCRIPTION OF THE DRAWINGS

FIG. 1 is a side view of an exemplary boltless pipe joint assembly.

FIG. 2 illustrates the opening of an exemplary embodiment of a boltless pipe joint assembly.

FIG. 3 is a cross-sectional view of an exemplary embodiment of a boltless pipe joint assembly.

FIG. 4 illustrates a pipe joint using an exemplary boltless pipe joint assembly.

FIG. 5 illustrates a bend using exemplary boltless pipe joint assemblies.

FIG. 6 is an exemplary water main valve using boltless pipe joint assemblies.

FIG. 7 illustrates an exemplary water main valve using boltless pipe joint assemblies connected to water main pipes.

### GLOSSARY

As used herein, the term “bell housing” refers to a connecting end of a pipe which is flared or elongated to accommodate an interior groove for a gasket (or a rubber gasket) which fits outside of a connecting pipe and which is approximately two times as long as a standard bell housing known in the art.

As used herein, the term “bend” refers to a curved pipe component known in the art which changes the direction of water flow through a water main.

As used herein, the term “gasket” refers to any structure used to create a watertight seal at a joint.

As used herein, the term “mechanical pipe joint” refers to a pipe connection using hardware in addition to a gasket. Hardware may include, but is not limited to, bolts, lugs, flanges, glands, sockets or any combination thereof.

As used herein, the term “pipe collar” refers to an external, detached component which fully encircles a pipe and a gasket placed around the pipe, and which must be pushed or pounded into place to create a tight seal between the internal surface of the collar. A commercially available example of a pipe collar known in the art is the MEGALUG®.

As used herein, the term “pipe end” refers to the end of a pipe to be joined in a mechanical pipe joint.

As used herein, the term “precisely placed” refers to a gasket which has been specifically positioned within a pipe joint to form a water tight seal when joined to a water main or other pipe segment. A gasket may be precisely placed to correspond to a gasket recess, groove, contour, or other structure which secures a gasket. A gasket may also be precisely placed at a distance from the open end of a boltless pipe joint to accommodate a specific connection.

As used herein, the term “restrainer” refers to a structure against which a pipe is restrained to prevent movement of the pipe or pipes.

As used herein, the term “restraint component” refers to any structure or device which secures a boltless pipe joint to another segment of pipe. Restraint components may include, but are not limited to, breakaway components, bolts, rods, lugs, flanges, glands, sockets, fastening components, welded components or any other structure or device, known in the art to secure a boltless pipe joint to another segement of pipe, or combinations thereof.

As used herein, the term “slip joint” refers to an interlocking structural interface which connects one pipe to another. Slip joints may be molded with a groove or inner recess with a rubber gasket and may include a beveled edge.

As used herein, the term “water main” includes, but is not limited to, pipes which convey water, steam, sewage and pressurized sewage.

### BACKGROUND

Water main lines are large, underground pipes buried between 4 and 30 feet below ground. They are generally made of PVC or ductile iron. Specially trained utility contractors must be hired to work below ground to install and service water main lines.

Water supply lines are connected to water main lines to carry water into houses and other structures. Because water main lines supply water to a large area, water main lines must be able to accommodate large flow volumes and high pressures. A water main may be anywhere from six to 6 to 48 inches in diameter and must support a pressure of 60 to 100 psi or greater. Generally, the diameter of a water main is around 12 to 16 inches.

Water main lines are comprised of pipe segments. Every water main line segment has a bell end and a straight end, and segments are connected at joints. Bends, or curved connections, experience a phenomena called “dead end pressure.” Dead end pressure is an intensified pressure that occurs when the flow of water through a straight path within a water main is diverted to a curved path or “dead end.”

Bends must therefore be secure and structurally strong.

Pipe joints, which connect pipe segments, are complex mechanical assemblies that include multiple structural components which act together to prevent leaks and strengthen the joint to withstand the internal pressures. Typical pipe joint assemblies are comprised segments of water main pipe, a valve or bell component (which may be an integral part of a water main pipe), a separate restraint component, and bolts to fasten the pipes.

For example, when assembling water main segments at bends, the straight end of one segment is fitted with a gasket. The straight end is slid into the flanged, or bell shaped, end of a second segment, so that the pipe collar is adjacent to, but not overlapping, the gasket. The bell end has an internal surface which includes a gasket recess to accommodate the width of a gasket around the straight end of the first pipe segment. The purpose of the gasket is to seal the pipe to prevent leakage. This reinforcement is necessary.

The pipe collar must then be pounded into place by at least two assembly workers working below ground. As the pipe collar is pounded, the gasket is moved into place within the internal gasket recess of the bell end.

Assembly workers gradually, in a sequenced operation, partially and uniformly tighten each fastening bolt, returning to each bolt several times. Each fastening bolt must be incrementally and individually tightened to ensure that a proper seal and adequate pressure around the joint is maintained. If workers were to tighten each bolt fully, rather than partially, in several passes, a leak would result. Tightening each bolt partially ensures that a constant pressure is maintained on the gasket during the tightening process.

Pipe collar components known in the art, such as the MEGALUG® restraint, have eight or more fastening bolts which are tightened against the straight end of a pipe and bolted to the pipe collar.

Fastening bolts are generally made of carbon steel and are exposed to ground water, which is often acidic and promotes corrosion. Water main repairs are often necessary because the externally exposed fastening bolts erode and are highly prone to corrosion and failure.

Another type of bolt used in the process is the “restraining bolt.” Restraining bolts secure the curved pipe segment (bend) to the pipe collar. Restraining bolts are also called “breakaway lugs.” A breakaway lug (restraining bolt) is a torque-limiting, twist-off nut, commonly used for fastening bolts. Breakaway bolts must be broken by the assembly workers still working underground. Breakaway bolts are less susceptible to failure because they are not exposed to corrosive water elements.

This careful, tedious and labor-intensive fastening operation is necessary to secure the water main and the bend from the considerable dead end pressure to which these components will be exposed.

To further overcome the problem of leaking, some pipe bend joints have incorporated additional pressure fittings and blockings (e.g., concrete blocks to wedge a pipe or joint) to prevent movement caused by pressure. Blocking is a labor intensive, costly and sometimes imprecise process.

One problem known in the art is the high rate of failure of the exposed fastening bolts resulting in leaks.

A further problem known in the art is the time and complexity involved in properly assembling the pipe joint. Pipe joints must be assembled by underground workers, and each restraint and fastening bolt must be individually and incrementally tightened. Assembly workers must work below ground to ensure proper alignment of the pipe joint with restraints (e.g., MEGALUG®).

It is desirable to produce a mechanical pipe joint that addresses the problem of deteriorating fastening bolts and eliminates the use of bolts exposed to underground water conditions.

It is desirable to produce a boltless mechanical pipe joint for quick assembly in low pressure systems, without the requirement that assembly workers perform substantial installation operations below ground.

It is also desirable to reduce component parts and increase the efficiency of ins ailing joints in water mains.

It is also desirable to eliminate the need for additional blocking processes.

### SUMMARY OF THE INVENTION

The present invention is a boltless mechanical pipe joint having a curved segment of joint pipe with an elongated bell housing having an internal gasket recess which houses a prefabricated and precisely placed gasket. The elongated bell housing also includes a flange adapted to receive a plurality of restraint components which secure the boltless pipe joint to a second pipe segment. The bell housing is elongated to accommodate the internal gasket recess and flange.

By casting the segment of joint pipe, elongated bell housing with intern gasket recess and flange as a single component, there is no need for fastening bolts. The slip in joint, or joint which includes a prefabricated gasket, also eliminates the need for a pound-in gasket, resulting in a quicker installation time.

### DETAILED DESCRIPTION OF INVENTION

For the purpose of promoting an understanding of the present invention, references are made in the text to exemplary embodiments of a boltless mechanical pipe joint, only some of which are described herein. It should be understood that no limitations on the scope of the invention are intended by describing these exemplary embodiments. One of ordinary skill in the art will readily appreciate that alternate but functionally equivalent materials may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

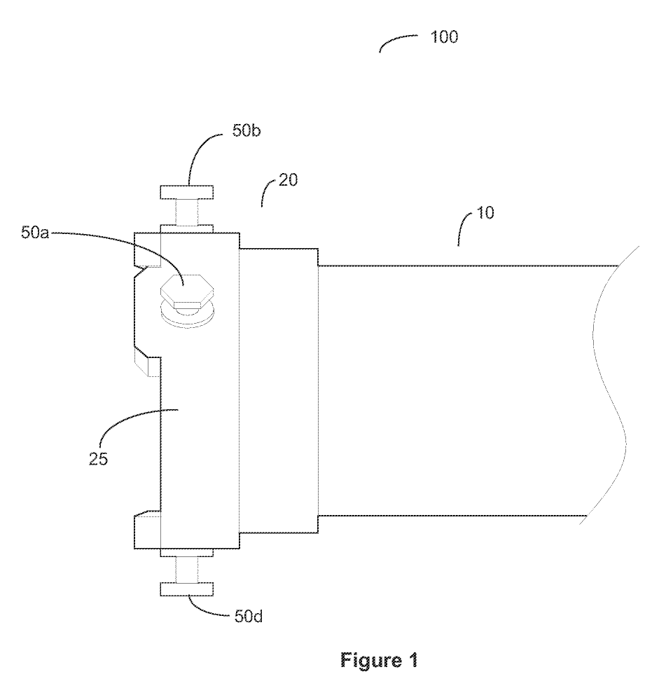

FIG. 1 is a side view of an exemplary embodiment of boltless pipe joint assembly 100. In the embodiment shown, boltless pipe joint assembly 100 includes pipe body component 10 and elongated bell housing 20. Elongated bell housing is a portion of the pipe which incorporates an internal gasket recess into which a prefabricated gasket is inserted and precisely placed. A prefabricated gasket is one which inserted in the device by the manufacturer and does not require a pounding or the process of pushing a gasket into place.

Elongated bell housing 20 further includes flange 25 which has a plurality of integrally constructed restraint components 50a, 50b, 50c and 50d. In the embodiment show, restraint components 50a, 50b, 50c and 50d are breakaway components but could be any bolt, rod, fastening component or welded component known in the art.

As illustrated in FIG. 1, flange 25 is distinguishable from elongated bell housing 20 by the increased outer diameter occurring at flange 25. In further exemplary embodiments, flange 25 may not create a distinct increase in outer diameter, but may be gradually structurally incorporated with elongated bell housing 20.

In the exemplary embodiment shown in FIG. 1, elongated bell housing 20 is twice as long as bell housing components known in the art. The added housing material is necessary to accommodate the gasket, but also provides additional structural support. Elongated bell housing 20 is a uniquely configured component to function as both a slip joint and a structural accommodation for internal gasket recess.

As illustrated, elongated bell housing 20 has a lengthened, contoured shape created by individual diameter increases. In further exemplary embodimetns, elongated bell housing 20 may be created by a single, gradual diameter increase. For example, in some exemplary embodiments, the external diameter of elongated bell housing 20 may gradually increase through flange 25, while the interior diameter of elongated bell housing 20 remains constant. In other exemplary embodiments, the interior diameter of elongated bell housing 20 may increase as well. In still further exemplary embodiments, elongated bell housing 20 may incorporate different materials to create a strengthened joint.

As shown in FIG. 1, elongated bell housing 20 has an outer surface shaped similar to a bell. In further exemplary embodiments, elongated bell housing 20 may be otherwise contoured or curved to create an outer edge with a larger external diameter than pipe body component 10.

It is significant that the exemplary boltless pipe joint assembly 100 shown is structurally designed to include three to ten inches of total pipe length, which is elongated to approximately twice the size of the current bell housing configurations known in the art. The embodiment shown utilizes a four inch elongated bell housing.

As illustrated in FIG. 1, boltless pipe joint assembly 100 requires no bolts and combines the fastening and restraining properties provided by the combination of restraining components and fastening bolts used in the prior art. Pipe body component 10 and elongated bell housing 20 with flange 25 is a singly manufactured component. In some exemplary embodiments, pipe body component 10 with elongated bell housing 20 and flange 25 is singly molded as one piece of cast. In further exemplary embodiments, pipe body component 10, elongated bell housing 20 and flange 25 may be manufactured as a single component through any method known in the art.

In still further exemplary embodiments, boltless pipe joint assembly 100 may be structurally configured as a single unit or assembly of combined or individual units structurally integrated to form one assembly.

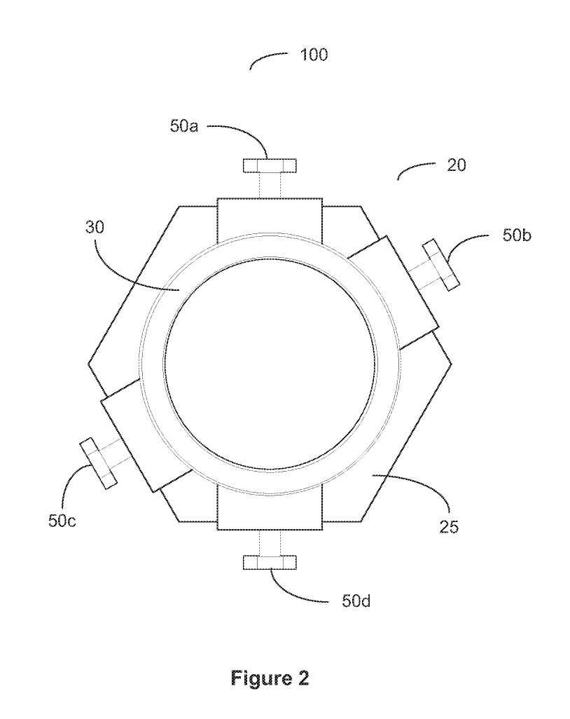

FIG. 2 illustrates an exemplary embodiment of the open end of elongated bell housing 20. In the exemplary embodiment shown, gasket 30 is recessed in elongated bell housing 20. In further exemplary embodiments, elongated bell housing 20 may include a groove or other structure which contains gasket 30. In still further exemplary embodiments, gasket 30 may be integrally assembled with elongated bell housing 20.

In the exemplary embodiment shown, gasket 30 is made of synthetic rubber. In other exemplary embodiments, gasket 30 may be made out of vegetable fiber, synthetic rubber with cloth fibers, Teflon, stainless steel or any other material known in the art used to create gaskets.

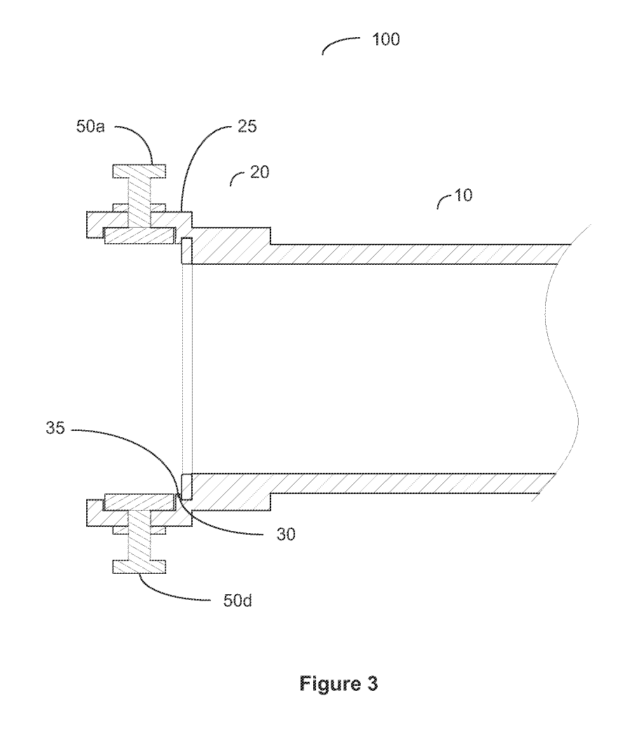

FIG. 3 is a cross-sectional view of an exemplary embodiment of boltless pipe joint assembly 100. As illustrated in FIG. 3, prefabricated gasket 30 is shown recessed within internal recess 35. Prefabricated gasket 30 is integrally assembled with elongated be housing 20, creating the elongated bell shape. As illustrated, gasket 30 is prefabricated and precisely and uniformly positioned within elongated bell housing 20.

In the exemplary embodiments shown in FIGS. 1, 2 and 3, boltless pipe joint assembly 100 is made of cast iron. In further exemplary embodiments, boltless pipe joint assembly 100 may be made of other materials known in the art used to make pipes, such as polyvinyl chloride (PVC) and ductile iron.

As illustrated in FIGS. 1-3, elongated bell housing 20 has an inner diameter which corresponds to the outer diameter of the pipe end to which it will be joined and uses four restraint components 50a, 50b, 50c, 50d. In still other embodiments, elongated bell housing 20 may be of varying diameters and may require more or fewer breakaway lugs.

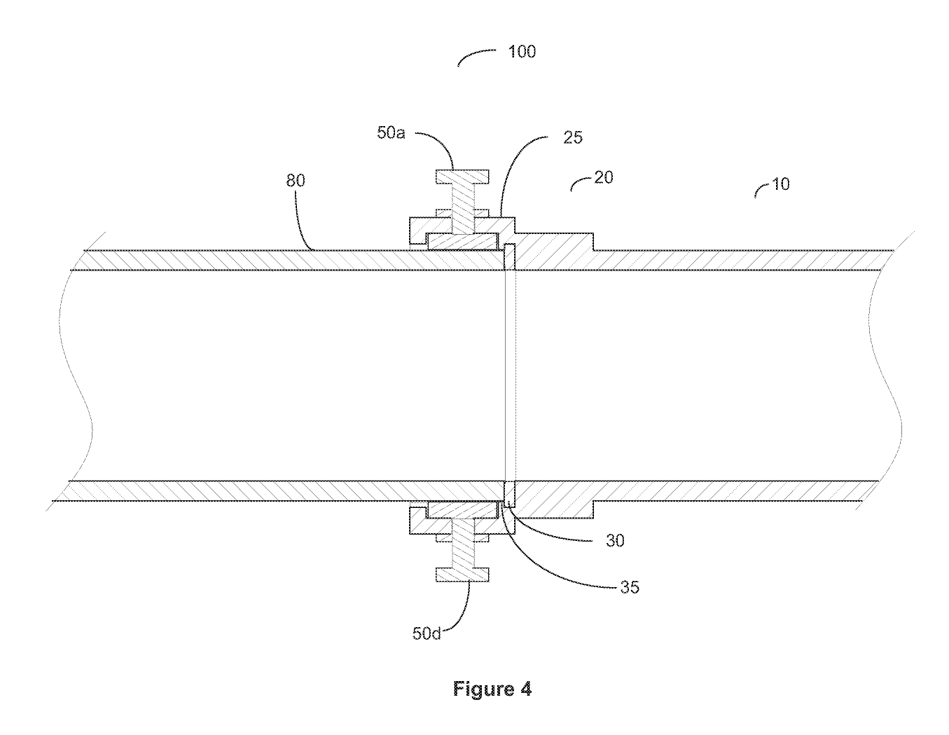

FIG. 4 illustrates a pipe joint utilizing an exemplary embodiment of boltless pipe joint assembly 100. Elongated bell housing 20 with gasket 30 and flange 25 receives second pipe end 80. In some exemplary embodiments, second pipe end 80 may be lubricated. Prefabricated gasket 30 creates a seal between elongated bell housing 20 and second pipe end 80. Restraint components 50a and 50d (and 50b and 50c not shown) are broken off to create pressure around elongated bell housing 20 and second pipe end 80, which aids gasket 30 in creating a seal and holding pipe ends 20 and 80 together.

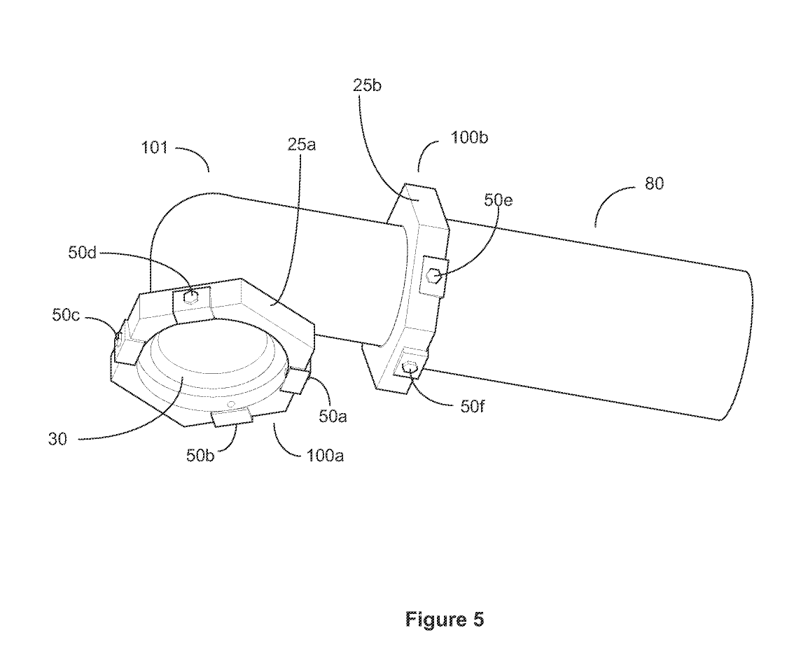

FIG. 5 is an exemplary embodiment of boltless pipe joints 100a, 100b in use with bend 101. As illustrated in FIG. 5, bend component 101 contains two pipe joint assemblies 100a, 100b, one on each end of bend 100. Bend component 101 is curved. Second pipe end 80 is connected to boltless pipe joint 100b, with boltless pipe joint 100a ready to be connected to a third pipe end.

Restraint components 50a, 50b, 50c, 50d are showed intact on flange 25a, while restraint components 50e, 50f (and 50g, 50h) on flange 25b are broken to securely hold second pipe end 80. Breaking restraint components 50 helps prevent corrosion because restraint components 50 are not exposed to the environment (e.g., ground water) when underground.

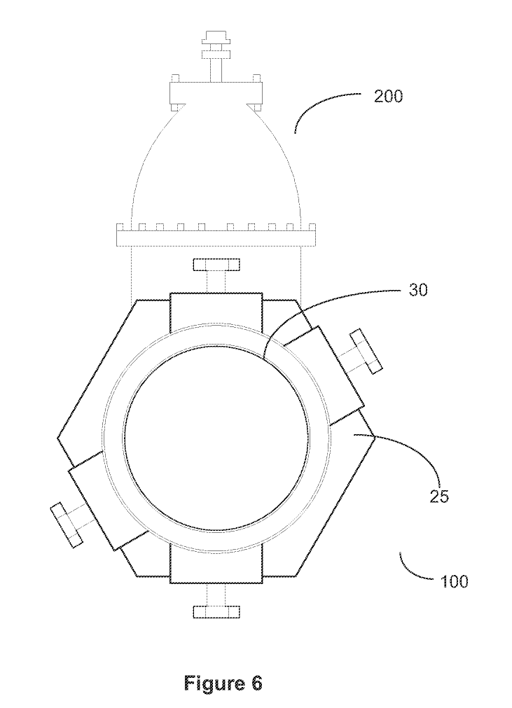

FIG. 6 is an exemplary embodiment of boltless pipe joint 100 in use with water main valve 200. In the exemplary embodiment shown, elongated bell housing 20 (not shown) with flange 25, pipe body component 10 (not shown) and water main valve 200 are manufactured as a singly cast component. Gasket 30 is prefabricated and integral with boltless pipe joint 100.

As illustrated in FIG. 6, gasket 30 is set back approximately 3 inches in elongated bell housing 20. In further exemplary embodiments, gasket 30 may be set further in elongated bell housing 20 or seated more toward flange 25.

In the exemplary embodiment shown FIG. 6, a single side of water main valve 200 is visible. Other sides of water main valve 200 may include additional joints using boltless pipe joint 100.

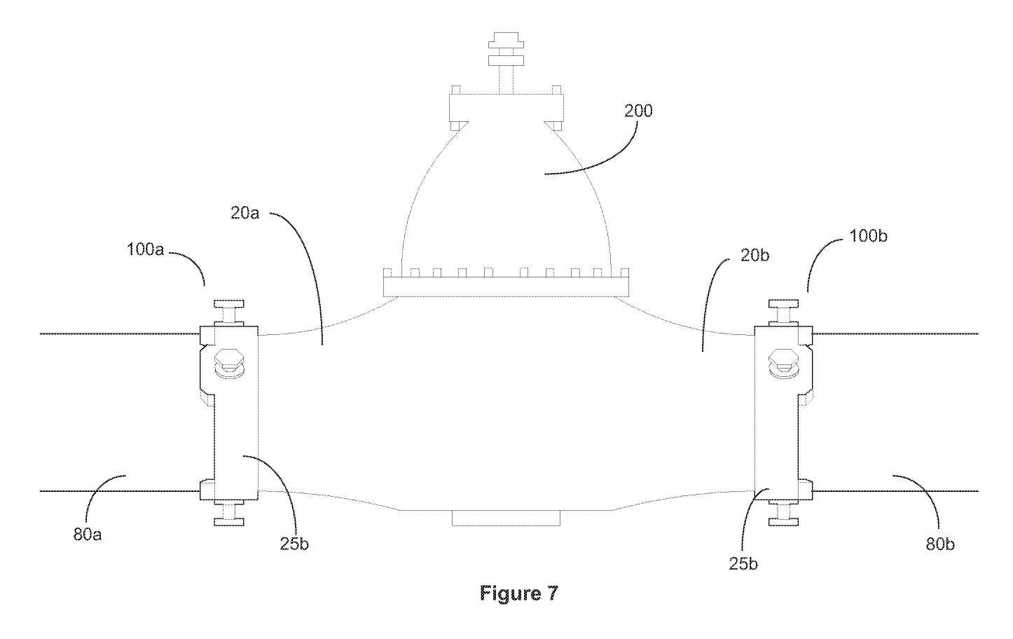

Water main valve 200 may contain two or more boltless pipe joints 100. In the exemplary embodiment illustrated in FIG. 7, water main valve 200 contains two joints, each using boltless pipe joint 100a, 100b. Pipe ends 80a, 80b connect to water main valve 200 using boltless pipe joints 100a, 100b, respectively. Elongated bell housing 20a, 20b, with flanges 25a, 25b, overlap pipe ends 80a, 80b to provide room for gaskets 30a, 30b (not shown) and more securely engage pipe ends 80a, 80b.

In further exemplary embodiments, components other than water main valves may use boltless pipe joints 100. For example, hydrants, crosses, tees, bends and other valve components may use one or more boltless pipe joints 100 to connect to other pipes. In still further exemplary embodiments, boltless pipe joint 100 may be constructed to interface securely with water main segments to form a variety of restraints, including, but not limited to, bend restraints, valve restraints and hydrant restraints.

What is claimed is:

1. A boltless pipe joint assembly comprised of:
a curved segment of joint pipe;
an elongated bell housing having at least one internal gasket recess into which a gasket has been prefabricated and precisely placed, said elongated bell housing further configured to form a slip joint;
at least three integrally manufactured restraint components; and
at least one flange to which said at least three integrally manufactured restraint components are affixed to secure said boltless pipe joint assembly to at least one water main.

2. The apparatus of claim 1 wherein said elongated bell housing, said flange, said curved segment of joint pipe and said internal gasket recess are a single molded component.

3. The apparatus of claim 1 wherein said elongated bell housing is capable of interacting with a water main to form form a slip joint and simultaneously accommodate a gasket recess.

4. The apparatus of claim 1 wherein said internal gasket recess and said prefabricated gasket are located at the center of said elongated bell housing.

5. The apparatus of claim 1 wherein said restrain components are breakaway bolts.

6. The apparatus of claim 1 which includes no fastening bolts.

7. The apparatus of claim 1 wherein said elongated bell housing is constructed to interface securely with a water main segment to form a bend restraint.

8. The apparatus of claim 1 wherein said elongated bell housing is constructed to interface securely with a water main pipe to form a valve restraint.

9. The apparatus of claim 1 wherein said elongated bell housing is constructed to interface securely with a water main pipe to form a hydrant restraint.

10. The apparatus of claim 1 wherein said elongated bell housing is four inches in length.

11. The apparatus of claim 1 wherein said elongated bell housing is two to four inches in length.

12. A system for forming a pipe joint assembly comprised of:
a straight water main component;
a pipe body;
a contoured component which forms an interface to be slidingly installed on said straight water main component, said contoured component further accommodating a prefabricated gasket; and
a flanged end adapted to receive a plurality of restraint components,
wherein said contoured component and said flanged end are a single component and secured to said pipe body.

13. The system of claim 12 wherein said contoured component is an elongated bell shape.

14. The system of claim 12 wherein said contoured component further includes a layer of lubrication on the interior surface.

15. The system of claim 12 wherein said contoured component further includes an internal gasket recess to accommodate said prefabricated gasket.

16. The system of claim 17 wherein said internal gasket recess and said prefabricated gasket are located at the center of said contoured component.

17. The system of claim 12 wherein said restrain components are breakaway bolts.

18. The system of claim 12 which includes no fastening bolts.

19. The system of claim 12 wherein said contoured component is constructed to interface securely with a water main pipe to form a bend restraint.

20. The system of claim 12 wherein said contoured component is constructed to interface securely with a water main pipe to form a valve restraint.

21. The system of claim 12 wherein said contoured component is constructed to interface securely with a water main pipe to form a hydrant restraint.

22. The system of claim 12 wherein said contoured component is four inches in length.

23. The system of claim 12 wherein said contoured component is two to four inches in length.
